(19) United States
(12) Patent Application Publication
(10) Pub. No.: US 2024/0217381 A1
(43) Pub. Date: Jul. 4, 2024

(54) BATTERY SWAPPING SYSTEM

(71) Applicants: Khaled M. Elleithy, Trumbull, CT (US); Mohamed A. Mohamed, Bridgeport, CT (US)

(72) Inventors: Khaled M. Elleithy, Trumbull, CT (US); Mohamed A. Mohamed, Bridgeport, CT (US)

(21) Appl. No.: 18/399,906

(22) Filed: Dec. 29, 2023

Related U.S. Application Data
(60) Provisional application No. 63/477,600, filed on Dec. 29, 2022.

(51) Int. Cl. B60L 53/80; B60L 53/302; B60L 58/26; B65G 51/04; H01M 10/613; H01M 10/625; H01M 10/6561; H01M 50/213; H01M 50/249; H01M 50/258; H01M 50/267; H01M 50/51

(52) U.S. Cl. CPC B60L 53/80; B60L 53/302; B60L 58/26; B65G 51/04; H01M 10/613; H01M 10/625; H01M 10/6561; H01M 50/213; H01M 50/249; H01M 50/258; H01M 50/267; H01M 50/51; H01M 2220/20

(57) ABSTRACT

A battery swapping system includes a battery shell installed in the electric vehicle. The battery shell includes a plurality of slots. A plurality of battery modules are installed in the plurality of slots of the battery shell. A battery pump includes a suction system, a propulsion system, and a hose for connecting the battery pump to the electric vehicle. The suction system is configured to remove a plurality of discharged battery modules from the battery shell and the propulsion system is configured to provide a plurality of charged battery modules into the battery shell. In some embodiments, the battery modules include a spherical body housing a plurality of battery cells therein. The spherical body includes bottom air vents for air cooling the battery cells, and top alignment holes for aligning the battery module with adjacent battery modules in series within a slot of the battery shell.

### CROSS REFERENCE TO RELATED APPLICATIONS

This application claims the priority benefit of U.S. Provisional Patent Application No. 63/477,600, filed Dec. 29, 2022, the contents of which is incorporated by reference as if disclosed herein in its entirety.

### FIELD

The present technology relates generally to battery systems, and more particularly, to battery modules and battery swapping systems for rechargeable batteries of electric vehicles.

### BACKGROUND

Electric vehicles have many advantages, but recharging the battery is time consuming and inconvenient. Fully charging the battery takes a long time and requires a special charging station.

Swapping the battery, either manually or automatically, is difficult because the batteries are very heavy. Manual battery swapping utilizes movement of the heavy battery between the car and the station, which is difficult even with the use of motorized equipment. Fully automated battery swapping systems face several challenges, including high-cost facilities and necessitating a large area to construct the system. This makes automatic battery swapping systems prohibitively expensive to the operator and/or customer and difficult to adopt without significant space available.

What is needed, therefore, are improved battery modules and battery swapping systems that address at least the problems described above.

### SUMMARY

According to an embodiment of the present technology, a battery swapping system for an electric vehicle is provided. The battery swapping system includes a battery shell installed in the electric vehicle. The battery shell includes a plurality of slots. A plurality of battery modules are installed in the plurality of slots of the battery shell. A battery pump includes a suction system, a propulsion system, and a hose for connecting the battery pump to the electric vehicle. The suction system is configured to remove a plurality of discharged battery modules from the battery shell and the propulsion system is configured to provide a plurality of charged battery modules into the battery shell.

In some embodiments, each of the plurality of battery modules include a positive terminal end and a negative terminal end opposite the positive terminal end. In some embodiments, the plurality of battery modules are installed end-to-end in series within each of the plurality of slots of the battery shell.

In some embodiments, each of the plurality of battery modules include a spherical body that has a top end, a bottom end opposite the top end, and an interior cavity that is configured to house a plurality of battery cells within the spherical body. At least one air vent is at the bottom end of the spherical body and is configured to provide air cooling to the plurality of battery cells within the spherical body. At least one alignment hole is at the top end of the spherical body and is configured to provide air flow through the spherical body for aligning the battery module with adjacent battery modules such that the battery modules are installed in series within the plurality of slots of the battery shell.

In some embodiments, the interior cavity defines a first battery cell housing and a plurality of second battery cell housings surrounding the first battery cell housing. The first battery cell housing is larger than the second battery cell housings. In some embodiments, the first battery cell housing is configured to house an 18650 battery and each of the plurality of second battery cell housings are configured to house a 14500 battery.

In some embodiments, each of the plurality of battery modules include a cylindrical body that has a rounded top end, a rounded bottom end opposite the rounded top end, and an interior cavity that is configured to house a plurality of battery cells within the cylindrical body. The interior cavity defines a plurality of battery cell housings.

In some embodiments, the plurality of battery cell housings includes a first row of battery cell housings and a second row of battery cell housings positioned atop the first row. The plurality of battery cell housings are configured to house 18650 batteries, 14500 batteries, or combinations thereof.

In some embodiments, the suction system and the propulsion system include a pneumatic pump. In some embodiments, the suction system and the propulsion system include flexible gears.

In some embodiments, a reservoir of battery modules is in communication with the battery pump. The reservoir is configured to charge battery modules and store both charged and discharged battery modules.

According to another embodiment of the present technology, a method of swapping battery modules in a rechargeable battery of an electric vehicle is provided. The method includes connecting a hose from a battery pump to the electric vehicle, suctioning discharged battery modules from a battery shell in the electric vehicle through the hose, propelling charged battery module into the battery shell in the electric vehicle through the hose, and disconnecting the hose from the electric vehicle. The discharged battery modules are stored in a reservoir in communication with the battery pump.

In some embodiments, the method further includes charging used battery modules in the reservoir and propelling the charged used battery modules into the battery shell. In some embodiments, the method further includes choosing a number of charged used battery modules for the battery pump to propel into the battery shell.

In some embodiments, the suctioning and propelling steps replace battery modules from a plurality of slots in the battery shell.

In some embodiments, the suctioning and propelling is done by a pneumatic pump.

In some embodiments, each battery module includes a spherical body that has a top end, a bottom end opposite the top end, and an interior cavity that is configured to house a plurality of battery cells within the spherical body. At least one air vent is at the bottom end of the spherical body and is configured to provide air cooling to the plurality of battery cells within the spherical body. At least one alignment hole is at the top end of the spherical body and is configured to provide air flow through the spherical body for aligning the battery module with adjacent battery modules such that the battery modules are installed in series within a slot of the battery shell.

According to yet another embodiment of the present technology, a spherical battery module for a rechargeable battery of an electric vehicle is provided. The spherical battery module includes a spherical body that has a top end, a bottom end opposite the top end, and an interior cavity that is configured to house a plurality of battery cells within the spherical body. At least one air vent is at the bottom end of the spherical body and is configured to provide air cooling to the plurality of battery cells within the spherical body. At least one alignment hole is at the top end of the spherical body and is configured to provide air flow through the spherical body for aligning the battery module with adjacent battery modules such that the battery modules are installed in series within a slot of a battery shell of the rechargeable battery. The interior cavity defines a first battery cell housing and a plurality of second battery cell housings surrounding the first battery cell housing. The first battery cell housing is larger than the second battery cell housings.

In some embodiments, the air flow for aligning the battery module with the adjacent battery modules within the slot of the battery shell is provided by a pneumatic pump of a battery pump that is configured to suction discharged battery modules from the battery shell and propel charged battery modules into the battery shell through a hose connected to the electric vehicle.

Further objects, aspects, features, and embodiments of the present technology will be apparent from the drawing Figures and below description.

### BRIEF DESCRIPTION OF DRAWINGS

Some embodiments of the present technology are illustrated as an example and are not limited by the figures of the accompanying drawings, in which like references may indicate similar elements.

FIG. 1 is a side view of a battery swapping system for an electric vehicle according to some embodiments of the present technology.

FIG. 2 is a top view of the battery swapping system of FIG. 1.

FIG. 3 is an isometric view of a battery swapping system for an electric vehicle according to some embodiments of the present technology.

FIG. 4 is an isometric detail view of a battery assembly installed in an electric vehicle according to some embodiments of the present technology.

FIG. 5A is a side view of a battery module having a positive terminal end and a negative terminal end according to some embodiments of the present technology.

FIG. 5B is a top view of a plurality of the battery modules of FIG. 5A arranged end-to-end in series.

FIG. 6A is an isometric view of a spherical battery module according to some embodiments of the present technology.

FIG. 6B is a cross-sectional view of the spherical battery module of FIG. 6A along section line A-A.

FIG. 7 is a plan view of the exterior of the top half portion of the spherical battery module of FIG. 6A.

FIG. 8 is a plan view of the interior of the top half portion of FIG. 7.

FIG. 9 is a plan view of the exterior of the bottom half portion of the spherical battery module of FIG. 6A.

FIG. 10 is a plan view of the interior of the bottom half portion of FIG. 9.

FIG. 11A is an isometric view of a cylindrical battery module according to some embodiments of the present technology.

FIG. 11B is an isometric view of the cylindrical battery module of FIG. 11A showing the batteries housed within in phantom.

FIG. 12A is an isometric view of a battery assembly according to some embodiments of the present technology.

FIG. 12B is an isometric view of detail B of FIG. 12A showing the battery modules in phantom.

### DETAILED DESCRIPTION

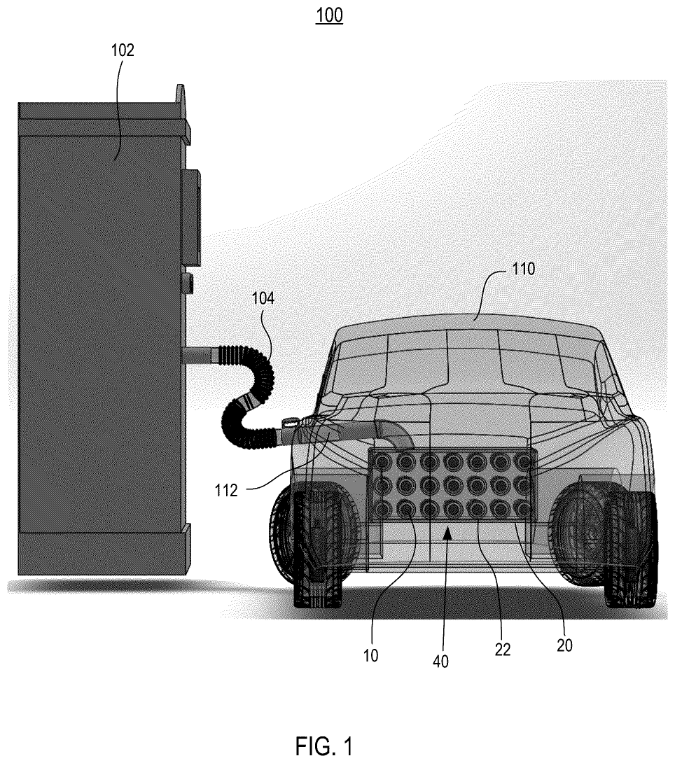

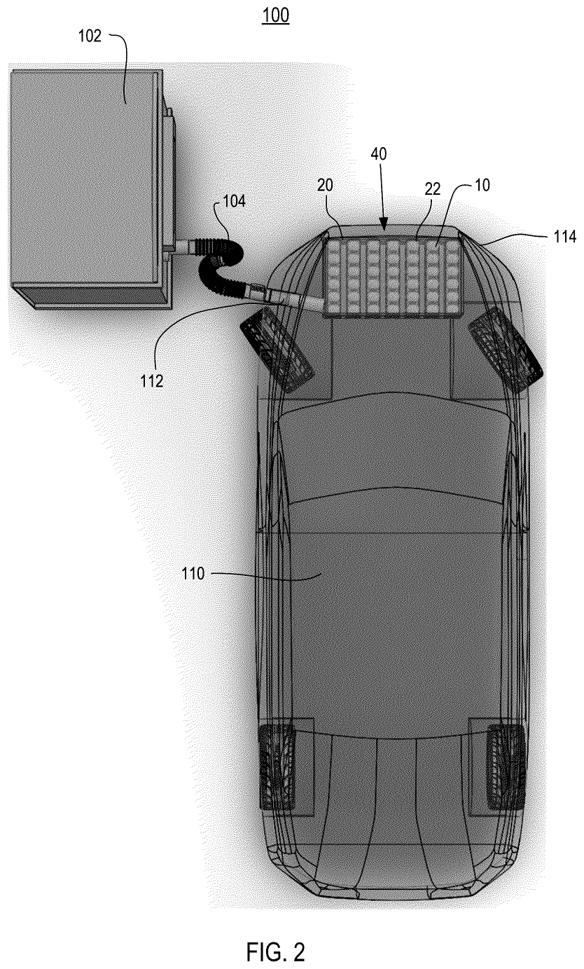

As shown in FIGS. 1-3, a battery swapping system is generally designated by the numeral 100. System 100 includes a battery shell 20 that is installed in an electric vehicle 110. Electric vehicle 110 is any vehicle that uses electric batteries instead of gasoline, including but not limited to cars, trucks, motorcycles, boats, and airplanes. Battery shell 20 includes a plurality of slots 22 that are each configured to house a plurality of battery modules 10. Each battery module 10 houses at least one battery cell 12 that are used for electrically powering electric vehicle 110. In some embodiments, battery cell 12 is a cylindrical, rechargeable battery such as an 18650 battery or 14500 battery, but the present technology is not limited thereto and contemplates battery cell 12 being other rechargeable battery of similar size, shape, voltage, and capacity.

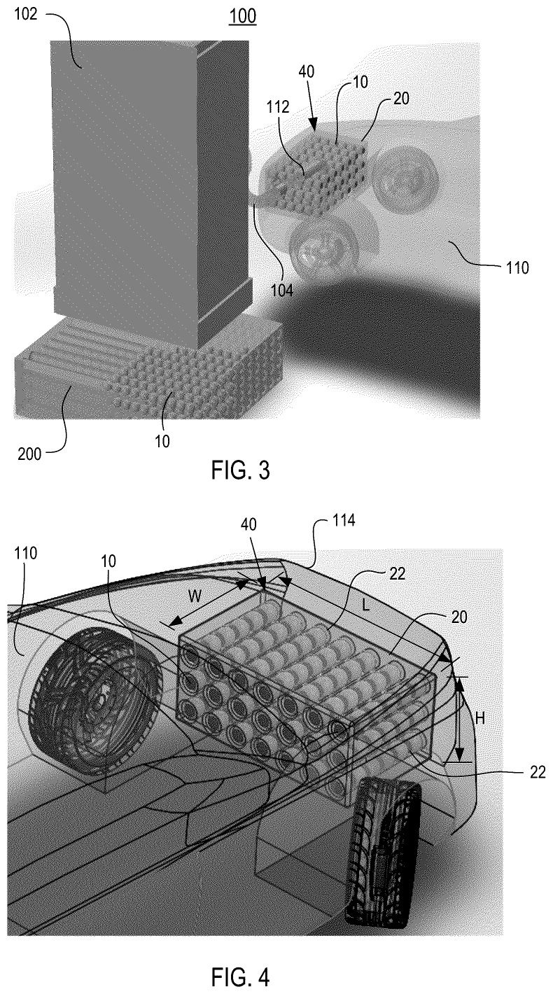

System 100 includes at least one battery pump 102 that is configured to remove used/discharged battery modules 10 from the battery shell 20 and provide charged (new and/or recharged used) battery modules 10 into the battery shell 20. The battery pump 102 includes a suction system, a propulsion system, and a hose 104. Hose 104 is configured to connect to the electric vehicle 110 via conduit 112. Hose 104 includes a smooth material interior and a flexible material exterior to allow smooth transfer of battery modules 20 from/to the electric vehicle 110. The suction system is configured to remove a plurality of discharged battery modules 10 from the battery shell 20, and the propulsion system is configured to provide a plurality of charged battery modules 20 into the battery shell 20. In some embodiments, the suction and propulsion systems include a pneumatic pump. In some embodiments, the suction and propulsion systems include flexible gears that transfer the battery modules 10 back and forth between the electric vehicle 110 and the battery pump 102 via a flexible rubber tube. In some embodiments, system 100 includes a reservoir 200 that is in communication with the battery pump 102. As shown in FIG. 3, reservoir 200 is configured to charge battery modules 10 and store both charged and discharged battery modules 10. In some embodiments, reservoir 200 is positioned beneath battery pump 102. In some embodiments, system 100 includes a cooling system for use on battery modules 10 before, during, and/or after the swapping process.

Thus, the battery pump 102 mimics a standard fuel pump and the method of using the device mimics the standard method of fueling a vehicle. The electric vehicle 110 pulls up next to the pump 102, as one normally would do to refuel a vehicle, to begin the battery module 10 exchange using the battery swapping system 100.

In some embodiments, system 100 withdraws discharged battery modules 10 from electric vehicle 110 to temporary storage in and/or under battery pump 102 to charge then to be ready for another vehicle. In some embodiments, system 100 pumps already charged sets of battery modules 10 from electric pump 102 to the battery shell 20. In some embodiments, a mechanism positions battery modules 10 end-to-end in battery shell 20, connecting them in series. In some embodiments, battery modules 10 are arranged during the pumping by the mechanism to connect them in the proper way, e.g., to supply energy to the vehicle propulsion motor. In some embodiments, the mechanism is an electro-mechanical system integrated with and/or adjacent to battery shell 20 to arrange battery modules 10, e.g., spherical battery modules, in series properly, e.g., via rotation, translation, etc.

Thus, in some embodiments, the process of replacing spent or discharged battery modules 10 with new, charged battery modules 10 is particularly similar to pumping gas into a traditional combustion engine vehicle. Referring to the embodiment shown in FIG. 3, a user inserts hose 104 of battery pump 102 into the electric vehicle 110, with a similar motion to inserting fuel in a conventional vehicle. When the user starts the process, battery pump 102 suctions the discharged battery modules 10 from the battery shell 20. In some embodiments, discharged battery modules 10 from the electric vehicle 110 are stored temporarily in and/or under the battery pump 102. In some embodiments, battery modules 10 are stored underground in reservoir 200. In some embodiments, battery modules are charged in battery pump 102, reservoir 200, proximate to battery pump 102 and/or reservoir 200, or combinations thereof, to be ready for the next electric vehicle 110. In some embodiments, discharged battery modules 10 are charged, e.g., in reservoir 200, by using a fast charger. In some embodiments, system 100 includes a plurality of reservoirs 200 to provide a plurality of batches of battery modules 10 to one or more electric vehicles 110.

In some embodiments, battery pump 102 propels charged battery modules 10, e.g., from reservoir 200, back into battery shell 20. Battery modules 10 are arranged during the pumping by a special mechanism to connect them in the proper way to be ready to supply energy to the vehicle propulsion motor, as discussed above. Finally, the user leaves with a fully charged battery assembly 40. In some embodiments, this battery swap process takes 5-10 minutes to complete and returns the electric vehicle 110 to the road faster than traditional chargers, similar to the time it takes to refuel a conventional vehicle. In some embodiments, the user selects how many of battery modules 10 they want to replace and/or recharge.

As shown in FIG. 4, battery shell 20 includes a length L, a width W, and a height H to accommodate a plurality of rows and columns of slots 22 for housing battery modules 10, thereby forming battery assembly 40. Battery shell 20 can be oriented in any suitable direction to accommodate placement within a vehicle, as will be discussed in greater detail below. In some embodiments, battery shell 20 is generally positioned horizontally, vertically, or combinations thereof. Battery shell 20 is composed of any suitable material to house battery modules 10, e.g., one or more metals, polymers, or combinations thereof.

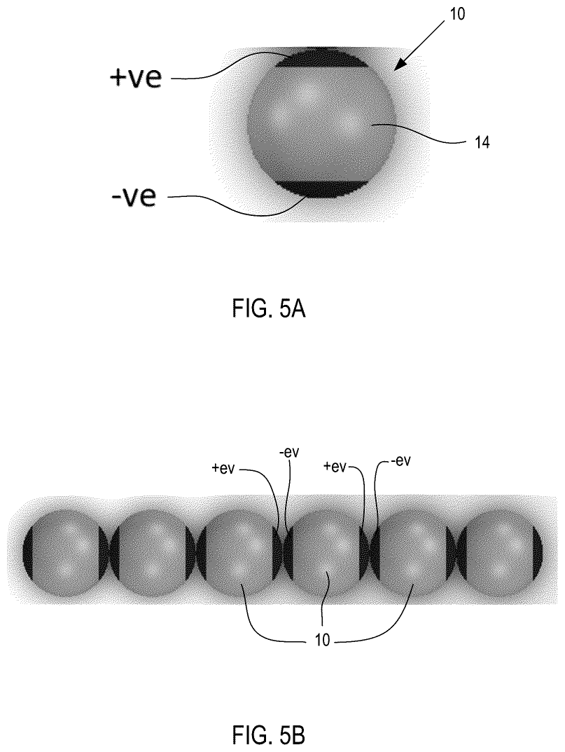

As shown in FIG. 5A, battery module 10 includes a body 14 that has a positive terminal end +ve and a negative terminal end −ve positioned opposite the positive terminal end +ve. In some embodiments, adjacent battery modules 10 are positioned end-to-end in series such that the positive terminal end +ve of a first battery module 10 is in contact with the negative terminal end −ve of a second battery module 10, and the negative terminal end −ve of the first battery module 10 is in contact with the positive terminal end +ve of a third battery module 10, as shown in FIG. 5B.

FIGS. 1-4 show an example embodiment of battery assembly 40 for use with spherical battery modules 10 and installed in an electric vehicle 110. Spherical battery modules 10 are connected in battery assembly 40, i.e., arranged terminal to terminal in series. Any suitable number of battery modules 10 can be included in battery assembly 40 so long as the number of battery cells 12 are sufficient for powering the desired vehicle or machine 110 for a desired duration. As with the embodiments discussed herein, battery modules 10 are removable from battery shell 20 via battery pumps 102.

In some embodiments, battery shell 20 is installed in the front part 114 of electric vehicle 110, as shown in FIGS. 1-4. In such embodiments, natural airflow is advantageously used during the vehicle's movement for cooling, either alone or in addition to a cooling system that is less costly and more power efficient when compared with the existing electric vehicle battery thermal management systems. In some embodiments, system 100 includes a control module that controls the natural air flow, the cooling system, the heating system in the vehicle, or combinations thereof, to control the battery cells' temperature. These embodiments also provide an extra volume for the electric vehicle batteries up to 15% of the total batteries volume, which means the energy density (Wh/kg) of the vehicle can increase. This advantage provides the electric vehicle 110 extra range by 15% or reducing the battery size by 15%. In some embodiments, battery shell 20 is installed in a different part of the electric vehicle 110, such as under the passenger cabin, in front of the passenger cabin, behind the passenger cabin, or combinations thereof. In some embodiments, battery shell 20 is installed proximate an exterior of the vehicle for increased ease of access to them and battery modules 10 positioned therein.

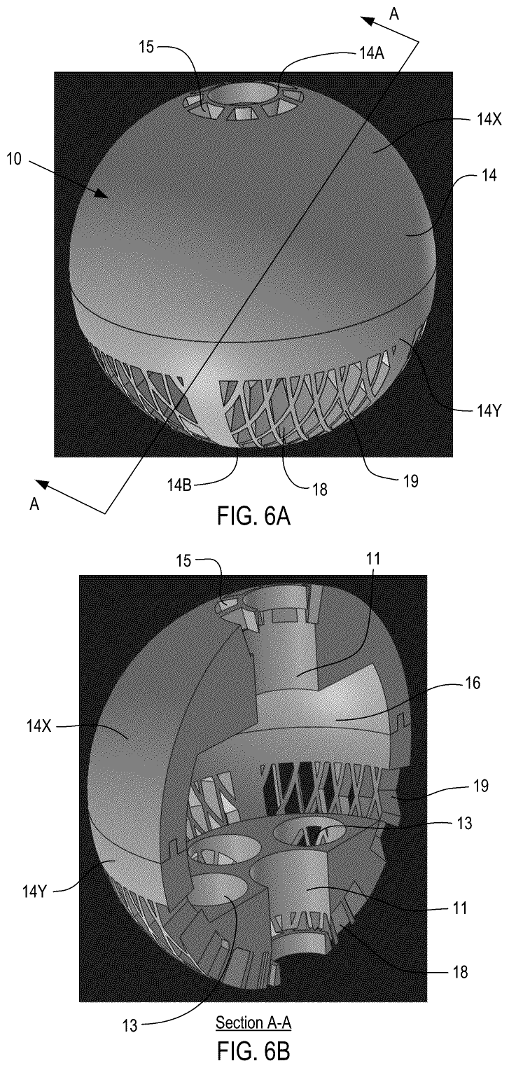

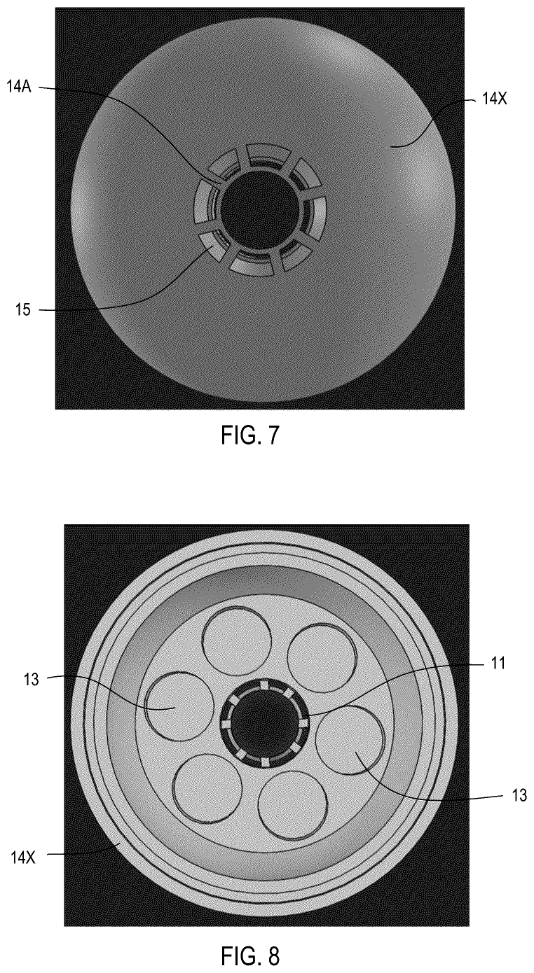

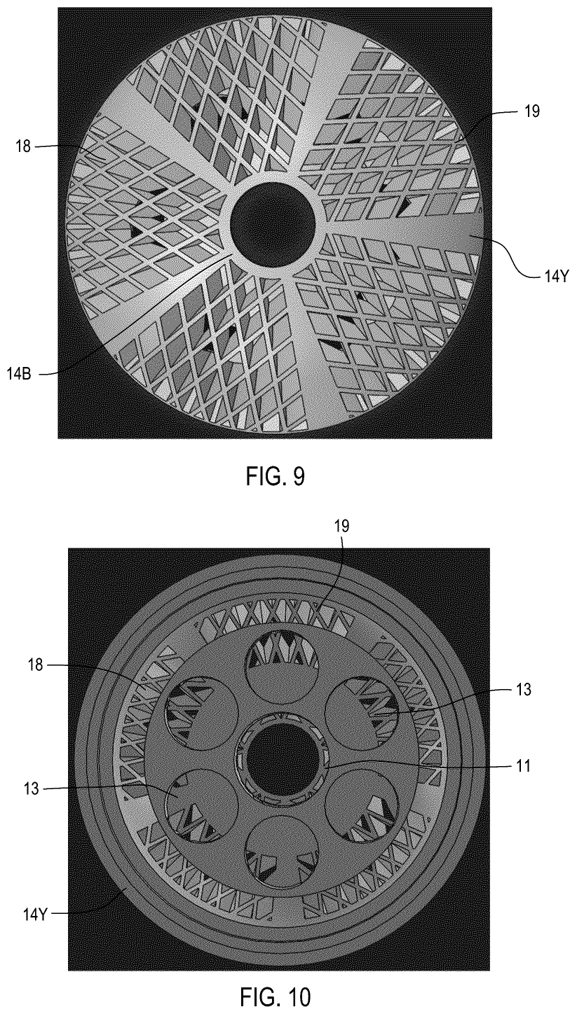

FIGS. 6A-10 show a spherical battery module 10 according to some embodiments of the present technology. The battery module 10 includes a spherical body 14 that has a top end 14A, a bottom end 14B opposite the top end 14A, and an interior cavity 16 that is configured to house a plurality of battery cells 12 within the spherical body 14. In some embodiments, the spherical body 14 includes a top half portion 14X that is connected to a bottom half portion 14Y, with the top end 14A on the top half portion 14X and the bottom end 14B on the bottom half portion 14Y. At least one air vent 18 is at and/or adjacent to the bottom end 14B. The air vent 18 is configured to provide air cooling to the battery cells 12 within the spherical body 12 during movement of the electric vehicle 110, as discussed above. In some embodiments, the at least one air vent 18 includes a plurality of spiral ventilated holes defined by a spiral mesh structure 19 that is configured to aerodynamically improve air flow into the spherical body 14 for air cooling the battery cells 12 without reducing the structural integrity of the spherical body 14. At least one alignment hole 15 is at and/or adjacent to the top end 14A. The alignment hole 15 is configured to provide air flow through the spherical body 14 for aligning the battery module 10 with adjacent battery modules 10 such that the battery modules 10 are installed in terminal-to-terminal (i.e., end-to-end) series within a slot 22 of the battery shell 20, as discussed above. In some embodiments, the at least one alignment hole 15 includes a plurality of radial ventilated holes at the top end 14A.

The interior cavity 16 defines a first battery cell housing 11 and at least one second battery cell housing 13, as shown in FIG. 6B. The first battery cell housing 11 is larger (e.g., has a greater length as measured between the top end 14A and the bottom end 14B) than the second battery cell housing 13 such that the first battery cell housing 11 is configured to house a larger (e.g., physically longer, more voltage, more capacity, etc.) battery cell 12 than a battery cell 12 housed within the second battery cell housing 13. In some embodiments, the interior cavity 16 includes a plurality of second battery cell housings 13 that surround the first battery cell housing 11. In some embodiments, the first battery cell housing 11 is centrally located within the interior cavity 16 and is surrounded by six second battery cell housings 13, as shown in FIGS. 6B, 8, and 10. In some embodiments, the first battery cell housing 11 is configured to house an 18650 battery and each of the second battery cell housings 13 are configured to house a 14500 battery. However, the present technology is not limited thereto and contemplates embodiments where the interior cavity 16 houses other appropriate batteries, as discussed above. In some embodiments, all the batteries in the battery module 10 are connected in parallel and the battery module 10 includes one positive terminal end and one negative terminal end, as discussed above.

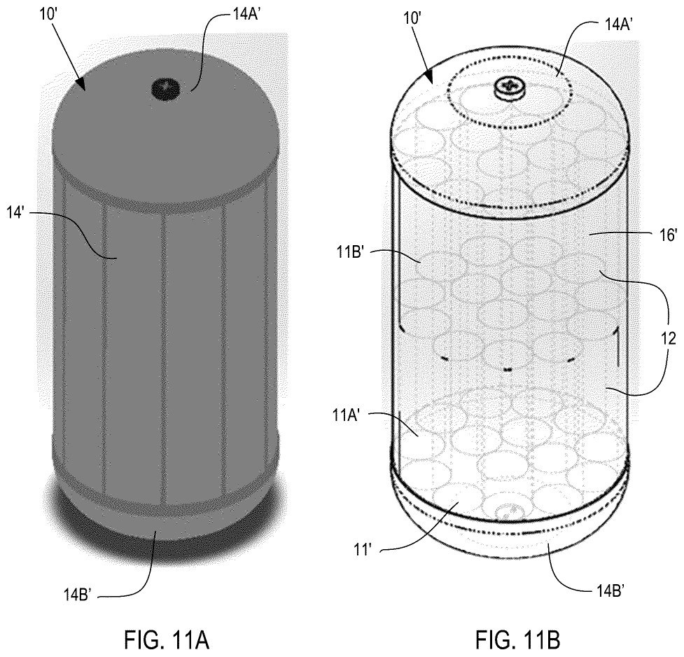

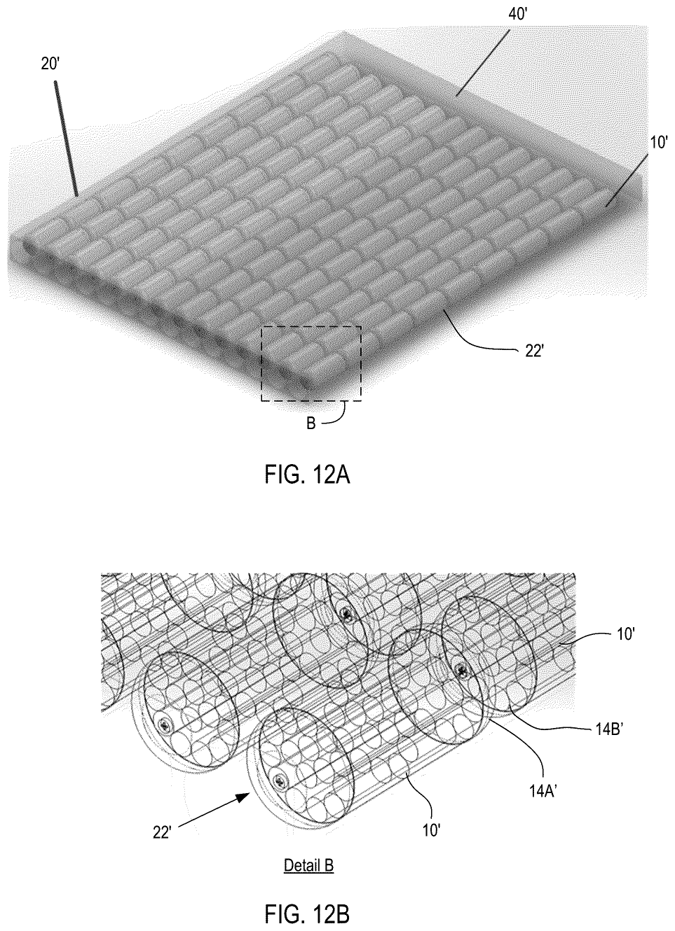

FIGS. 11A-11B show a cylindrical battery module 10′ according to some embodiments of the present technology. The battery module 10′ includes a cylindrical body 14′ that has a rounded top end 14A′, a rounded bottom end 14B′, and an interior cavity 16′ that is configured to house a plurality of battery cells 12 within the cylindrical body 14′. The interior cavity 16′ defines a plurality of battery cell housings 11′. In some embodiments, the plurality of battery cell housings 11′ includes a first row 11A′ and a second row 11B′ positioned atop the first row 11A′. The battery cell housings 11′ are configured to house battery cells 12, such as 18650 batteries, 14500 batteries, or combinations thereof. However, the present technology is not limited thereto and contemplates embodiments where the interior cavity 16′ houses other appropriate batteries, as discussed above. In some embodiments, all the batteries in the battery module 10′ are connected in parallel and the battery module 10′ includes one positive terminal end and one negative terminal end, as discussed above. In some embodiments, cylindrical battery modules 10′ are installed into battery shell 20′ to form battery assembly 40′, as shown in FIGS. 12A-12B. Battery modules 10′ are installed in terminal-to-terminal (i.e., end-to-end) series within a slot 22′ of the battery shell 20′, as discussed above.

In some embodiments, the battery modules are arranged in the electric vehicle battery assembly and in the battery pump charger to be connected in series, then the battery module slots are grouped to connect in parallel and series, according to the battery assembly voltage specifications. In some embodiments, the direction of movement of the spherical battery modules through the swapping pipes and hoses is controlled by the air movement through the modules. In some embodiments, the air enters from the bottom half portion of the spherical battery module body, pushes on the module's substantially solid top half portion toward the desired direction, and finally flows fast from the alignment holes in the top end of the top half portion that helps keep the spherical battery module's direction. In some embodiments, all the battery modules are arranged toward the desired direction in both the vehicle battery assembly and the battery pump charger. In some embodiments, the interior cavity of the spherical battery module houses a single battery cell that has an unusual battery standard.

Accordingly, methods and systems of the present technology provide an improved way to recharge electric batteries for any driver without any outside help (self service). There is no need to build a specialized facility as battery swapping system 100 can be added to any gas station, rest area, parking lot, individual swapping stations, mobile swapping trucks, or other similar places of business. The process of replacing spent or discharged battery modules with new charged battery modules is like pumping gas into a traditional combustion engine vehicle. Finally, spherical battery modules 10 have many advantages over the existing cylindrical shape batteries in the market such as better thermal management and ease of movement via the conduits and hoses. The spherical battery module 10 consistent with embodiments of the present technology can be different in shape and specifications according to the vehicle size and application.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition, or step being referred to is an optional (not required) feature of the technology. The term “and/or” means any one of the items, any combination of the items, or all of the items with which this term is associated.

Each numerical or measured value in this specification is modified by the term “about.” The term “about” can refer to a variation of +5%, +10%, +20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents of carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third, and upper third, etc.

As will also be understood by one skilled in the art, all language such as “up to,” “at least,” “greater than,” “less than,” “more than,” “or more,” and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

What is claimed is:

1. A battery swapping system for an electric vehicle, comprising:
a battery shell installed in the electric vehicle, the battery shell comprising a plurality of slots;
a plurality of battery modules installed in the plurality of slots of the battery shell; and
a battery pump comprising a suction system, a propulsion system, and a hose for connecting the battery pump to the electric vehicle;
wherein the suction system is configured to remove a plurality of discharged battery modules from the battery shell and the propulsion system is configured to provide a plurality of charged battery modules into the battery shell.

2. The battery swapping system of claim 1, wherein each of the plurality of battery modules comprises a positive terminal end and a negative terminal end opposite the positive terminal end.

3. The battery swapping system of claim 2, wherein the plurality of battery modules are installed end-to-end in series within each of the plurality of slots of the battery shell.

4. The battery swapping system of claim 1, wherein each of the plurality of battery modules comprises:
a spherical body having a top end, a bottom end opposite the top end, and an interior cavity configured to house a plurality of battery cells within the spherical body;
at least one air vent at the bottom end of the spherical body configured to provide air cooling to the plurality of battery cells within the spherical body; and
at least one alignment hole at the top end of the spherical body configured to provide air flow through the spherical body for aligning the battery module with adjacent battery modules such that the battery modules are installed in series within the plurality of slots of the battery shell.

5. The battery swapping system of claim 4, wherein the interior cavity defines a first battery cell housing and a plurality of second battery cell housings surrounding the first battery cell housing, the first battery cell housing is larger than the second battery cell housings.

6. The battery swapping system of claim 5, wherein the first battery cell housing is configured to house an 18650 battery and each of the plurality of second battery cell housings are configured to house a 14500 battery.

7. The battery swapping system of claim 1, wherein each of the plurality of battery modules comprises a cylindrical body having a rounded top end, a rounded bottom end opposite the rounded top end, and an interior cavity configured to house a plurality of battery cells within the cylindrical body, the interior cavity defining a plurality of battery cell housings.

8. The battery swapping system of claim 7, wherein the plurality of battery cell housings comprises a first row of battery cell housings and a second row of battery cell housings positioned atop the first row, the plurality of battery cell housings are configured to house 18650 batteries, 14500 batteries, or combinations thereof.

9. The battery swapping system of claim 1, wherein the suction system and the propulsion system comprise a pneumatic pump.

10. The battery swapping system of claim 1, further comprising a reservoir of battery modules in communication with the battery pump, the reservoir is configured to charge battery modules and store both charged and discharged battery modules.

11. A method of swapping battery modules in a rechargeable battery of an electric vehicle, the method comprising:
connecting a hose from a battery pump to the electric vehicle;
suctioning discharged battery modules from a battery shell in the electric vehicle through the hose;
propelling charged battery module into the battery shell in the electric vehicle through the hose; and
disconnecting the hose from the electric vehicle;
wherein the discharged battery modules are stored in a reservoir in communication with the battery pump.

12. The method of claim 11, further comprising charging used battery modules in the reservoir and propelling the charged used battery modules into the battery shell.

13. The method of claim 12, further comprising choosing a number of charged used battery modules for the battery pump to propel into the battery shell.

14. The method of claim 11, wherein the suctioning and propelling steps replace battery modules from a plurality of slots in the battery shell.

15. The method of claim 11, wherein the suctioning and propelling is done by a pneumatic pump.

16. The method of claim 11, wherein each battery module comprises:
a spherical body having a top end, a bottom end opposite the top end, and an interior cavity configured to house a plurality of battery cells within the spherical body;
at least one air vent at the bottom end of the spherical body configured to provide air cooling to the plurality of battery cells within the spherical body; and
at least one alignment hole at the top end of the spherical body configured to provide air flow through the spherical body for aligning the battery module with adjacent battery modules such that the battery modules are installed in series within a slot of the battery shell.

17. The method of claim 16, wherein the interior cavity defines a first battery cell housing and a plurality of second battery cell housings surrounding the first battery cell housing, the first battery cell housing is larger than the second battery cell housings.

18. The method of claim 17, wherein the first battery cell housing is configured to house an 18650 battery and each of the plurality of second battery cell housings are configured to house a 14500 battery.

19. A spherical battery module for a rechargeable battery of an electric vehicle, the spherical battery module comprising:
a spherical body having a top end, a bottom end opposite the top end, and an interior cavity configured to house a plurality of battery cells within the spherical body;
at least one air vent at the bottom end of the spherical body configured to provide air cooling to the plurality of battery cells within the spherical body; and
at least one alignment hole at the top end of the spherical body configured to provide air flow through the spherical body for aligning the battery module with adjacent battery modules such that the battery modules are installed in series within a slot of a battery shell of the rechargeable battery;
wherein the interior cavity defines a first battery cell housing and a plurality of second battery cell housings surrounding the first battery cell housing, the first battery cell housing is larger than the second battery cell housings.

20. The spherical battery module of claim 19, wherein the air flow for aligning the battery module with the adjacent battery modules within the slot of the battery shell is provided by a pneumatic pump of a battery pump configured to suction discharged battery modules from the battery shell and propel charged battery modules into the battery shell through a hose connected to the electric vehicle.
